(19) United States
(12) Patent Application Publication
(10) Pub. No.: US 2025/0005164 A1
(43) Pub. Date: Jan. 2, 2025

(54) SYSTEMS AND METHODS UTILIZING HARDWARE MODELS TO DETECT SIDE-CHANNEL VULNERABILITIES IN PROCESSOR DESIGNS

(71) Applicant: Microsoft Technology Licensing, LLC, Redmond, WA (US)

(72) Inventors: Gustavo Kenneth CONTRERAS MUNOZ, Westborough, MA (US); Connor William SHUGG, Chapel Hill, NC (US); Aidan Dexter MAYCOCK, Durham, NC (US); Oleksii OLEKSENKO, Cambridge (GB); Boris Alexander KOEPF, Cambridge (GB)

(21) Appl. No.: 18/214,960

(22) Filed: Jun. 27, 2023

(51) Int. Cl. G06F 21/57; G06F 21/56

(52) U.S. Cl. CPC G06F 21/577; G06F 21/566; G06F 2221/033

(57) ABSTRACT

Embodiments of systems and methods utilizing hardware models to detect side-channel vulnerabilities in processor designs are disclosed. Programs and inputs are tested in an instruction set simulator. Implementing the processor design in the instruction set simulator generates contract traces. A hardware simulator is implemented of the processor design. Implementing the hardware simulator results in hardware traces that indicate the data and execution are observable as a result of the hardware simulation. If the data and execution indicated by any of the hardware traces is not the same as that the data and execution indicated by at least one of the contract traces, a side-channel vulnerability is detected. Since the side-channel vulnerability was detected using a hardware simulation, an actual physical processor with the hardware design does not have to be used to test the hardware for the processor design.

### FIELD OF THE DISCLOSURE

This disclosure relates generally to systems and methods for detecting side-channel vulnerabilities in processor designs.

### BACKGROUND

Modern processors are configured to perform speculative execution in order to operate more efficiently. Speculative execution is an optimization technique where a processor predicts what set of instructions are most likely to be needed during the execution of a task and executes the predicted set of instructions ahead of knowing what instruction branch the processor will actually be following. Speculative execution sometimes results in incorrect instruction branches being executed by a processor. However, the inefficiency in sometimes executing the incorrect instruction branch is more than made up for in not having to wait for an in-order set of instructions to be provided during the execution of tasks. In other words, executing instructions ahead of time results in more efficient use of a processors pipeline circuitry (which is capable of implementing multiple sets of instructions in parallel) despite the execution of incorrect instruction branches.

Unfortunately, speculative execution also exposes a processor to attacks from hackers. When a processor speculatively performs operations that would not occur during correct program execution, data and execution techniques are observable to an attacker via a side channel. Being able to control and limit the data and execution exposed during speculative execution is now an important part of modern cybersecurity.

Speculation contracts are now used to determine what data and execution processes should be observable during speculative execution and what data and execution is to remain undetectable. Speculation contracts declare which operations an attacker can observe through a side channel, and which operations can speculatively change the control/data flow. For example, a contract may declare that an attacker can observe addresses of memory, store operations from memory, and load operations from memory, and that a central processing unit (CPU) may mispredict the targets of conditional jumps.

However, speculation contracts often depend on abstractions of the actual processes being implemented in a processor. As such, an actual processor must be experimentally tested to determine if the processor complies with the speculation contract. If there are data and/or execution processes that are observable during the actual execution of the processor that are not declared in the speculation contract, the processor violates the speculation contract. The processor must then be studied to determine what caused the contract violation and then the processor design for the processor must be reconfigured to eliminate the contract violation. Unfortunately, actually having to generate a physical processor with a particular processor design in order to test the processor design takes time and resources. Reducing the time and resources required to eliminate contract violations is important to improving the process of designing a processor.

### SUMMARY

Embodiments of systems and methods utilizing hardware models to detect side-channel vulnerabilities in processor designs are disclosed. Programs and inputs are tested in an instruction set simulator, which implements a speculation contract. Implementing the processor design in the instruction set simulator generates contract traces that indicate the data and execution observable in accordance with the speculation contract for the processor design. In addition, a hardware simulator is implemented of the processor design. Implementing the hardware simulator results in hardware traces that indicate the data and execution are observable as a result of the hardware simulation. If the data and execution indicated by any of the hardware traces that correspond to contract traces in the same input class do not match, a side-channel vulnerability is detected. Since the side-channel vulnerability was detected using a hardware simulation, an actual physical processor with the hardware design does not have to be used to test the hardware for the processor design.

In some embodiments, a method of detecting one or more side channels in a processor design, includes: obtaining a program and a set of inputs for the program; performing the program based off the set of inputs in an instruction set simulator of the processor design to obtain a plurality of contract traces for the processor design; performing the program based off the set of inputs in a hardware simulator of the processor design to obtain a plurality of hardware traces for the processor design; and comparing at least one contract trace of the plurality of contract traces and at least one hardware trace of the plurality of the hardware traces to determine whether there are one or more side-channel vulnerabilities. In some embodiments, the method further includes: obtaining a set of programs and sets of inputs, wherein each set of inputs of the sets of inputs corresponds to a different program of the set of programs and wherein obtaining the set of programs and the sets of inputs includes obtaining the program and the set of inputs for the program; performing each one of the programs in the set of programs based on the corresponding set of inputs in the instruction set simulator of the processor design to obtain pluralities of contract traces for the processor design, wherein each of the pluralities of contract traces corresponds to a different one of the programs and a different set of the inputs, wherein performing each one of the programs based on the corresponding set of inputs in the instruction set simulator of the processor design includes performing the program based of the set of inputs in the instruction set simulator of the processor design to obtain the plurality of contract traces for the processor design; performing each one of the programs in the set of programs based on the corresponding set of inputs in the hardware simulator of the processor design to obtain pluralities of hardware traces for the processor design, wherein each of the pluralities of the hardware traces corresponds to a different one of the programs and a different set of the inputs, wherein performing each one of the programs based on the corresponding set of inputs in the hardware simulator includes performing the program based of the set of inputs in the hardware simulator of the processor design to obtain the plurality of hardware traces for the processor design; and comparing the at least one contract trace of each of the pluralities of contract traces and the at least one hardware trace of each of the pluralities of the hardware traces to determine whether there are one or more side-channel vulnerabilities, wherein comparing the at least one contract trace of each of the pluralities of contract traces and the at least one hardware trace of each of the pluralities of the hardware traces to determine whether there are one or more side-channel vulnerabilities includes comparing the at least one contract trace of the plurality of contract traces and the at least one hardware trace of the plurality of the hardware traces to determine whether there are one or more side-channel vulnerabilities. In some embodiments, comparing the at least one contract trace of the plurality of contract traces and the at least one hardware trace of the plurality of the hardware traces to determine whether there are one or more side-channel vulnerabilities includes: determining one or more groups of contract traces, each group of contract traces includes contract traces generated as a result of implementing the same program with different inputs; for each of the one or more groups of contract traces, comparing corresponding hardware traces to one another to determine whether there is a mismatch between any of the hardware traces; for each group of the one or more groups of contract traces, detect a side-channel vulnerability of the one or more side-channel vulnerabilities for each instance that there is mismatch between any of the hardware traces in the group. In some embodiments, the program is a first program, the set of inputs is a first set of inputs, the plurality of contract traces are first contract traces, the plurality of hardware traces are first hardware traces, the one or more side-channel vulnerabilities are one or more first side-channel vulnerabilities, the method further includes: obtaining a second program and a second set of inputs for the second program; implementing the second set of inputs and the second program in the instruction set simulator of the processor design to obtain second contract traces; implementing the second set of inputs and the second program in the hardware simulator of the processor design to obtain second hardware traces; and comparing the second contract traces and the second hardware traces to determine whether there are one or more second side-channel vulnerabilities. In some embodiments, obtaining the program and the set of inputs for the program includes generating the program and the set of inputs with a side-channel central processing unit (CPU) fuzzer that generates the program and the set of inputs based on a program seed and an input seed. In some embodiments, the method further includes: generating a master seed; and generating the program seed and the input seed with a seed generator based on the master seed. In some embodiments, the method further includes implementing a verification environmental interface to prepare the program seed and the input seed to be functional with the side-channel CPU fuzzer before the side-channel CPU fuzzer generates the program and the set of inputs based on the program seed and the input seed. In some embodiments, comparing at least one contract trace of the plurality of contract traces and at least one hardware trace of the plurality of hardware traces to determine whether there are one or more side-channel vulnerabilities includes: implementing an aggregator that generates database entries associating contract traces and hardware traces; storing the database entries in a database; and implementing a database analyzer that compares the contract traces and the hardware traces to determine the one or more side-channel vulnerabilities. In some embodiments, obtaining the program and the set of inputs for the program includes generating the program and the set of inputs with a side-channel CPU fuzzer that generates the program and the set of inputs based on a program seed and an input seed. In some embodiments, the method further includes: generating a master seed; and generating the program seed and the input seed with a seed generator based on the master seed. In some embodiments, the method further includes implementing a verification environmental interface to prepare the program seed and the input seed to be functional with the side-channel CPU fuzzer before the side-channel CPU fuzzer generates the program and the set of inputs based on the program seed and the input seed. In some embodiments, performing the program based off the set of inputs in an instruction set simulator of the processor design to obtain a plurality of contract traces for the processor design includes implementing the instruction set simulator in accordance with a speculation contract that indicates the contract traces based on the program and the set of inputs. In some embodiments, the hardware simulator of the processor design is a register transfer level (RTL) simulator.

In some embodiments, a computational device, includes: one or more processors; and a non-transitory computer readable medium that stores computer executable instructions, wherein, in response to executing the computer executable instructions, the one or more processors are configured to: obtain a program and a set of inputs for the program; implement the set of inputs and the program in an instruction set simulator of a processor design to obtain contract traces; implement the set of inputs and the program in a hardware simulator of the processor design to obtain hardware traces; and compare the contract traces and the hardware traces to determine whether there are one or more side-channel vulnerabilities. In some embodiments, the program is a first program, the set of inputs is a first set of inputs, the contract traces are first contract traces, the hardware traces are first hardware traces, the one or more side-channel vulnerabilities are one or more first side-channel vulnerabilities, wherein, in response to executing the computer executable instructions, the one or more processors are further configured to: obtain a second program and a second set of inputs for the second program; implement the second set of inputs and the second program in the instruction set simulator of the processor design to obtain second contract traces; implement the second set of inputs and the second program in the hardware simulator of the processor design to obtain second hardware traces; and compare the second contract traces and the second hardware traces to determine whether there are one or more second side-channel vulnerabilities. In some embodiments, to obtain the program and the set of inputs for the program, the one or more processors are configured to generate the program and the set of inputs with a side-channel CPU fuzzer that generates the program and the set of inputs based on a program seed and an input seed. In some embodiments, in response to executing the computer executable instructions, the one or more processors are further configured to: generate a master seed; and generate the program seed and the input seed with a seed generator based on the master seed. In some embodiments, to compare the contract traces and the hardware traces to determine whether there are one or more side-channel vulnerabilities, the one or more processors are configured to: implement an aggregator that generates database entries associating the contract traces and the hardware traces; store the database entries in a database; and implement a database analyzer that compares the contract traces and the hardware traces to determine the one or more side-channel vulnerabilities.

In some embodiments, a non-transitory computer readable medium that stores computer executable instructions, wherein, in response to executing the computer executable instructions, one or more processors are configured to: obtain a program and a set of inputs for the program; implement the set of inputs and the program in an instruction set simulator of a processor design to obtain contract traces; implement the set of inputs and the program in a hardware simulator of the processor design to obtain hardware traces; and compare the contract traces and the hardware traces to determine whether there are one or more side-channel vulnerabilities. In some embodiments, to obtain the program and the set of inputs for the program, the one or more processors are configured to generate the program and the set of inputs with a side-channel CPU fuzzer that generates the program and the set of inputs based on a program seed and an input seed. In some embodiments, to compare the contract traces and the hardware traces to determine whether there are one or more side-channel vulnerabilities, the one or more processors are configured to: implement an aggregator that generates database entries associating the contract traces and the hardware traces; store the database entries in a database; and implement a database analyzer that compares the contract traces and the hardware traces to determine the one or more side-channel vulnerabilities.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a side-channel vulnerability detection module, in accordance with some embodiments;

FIG. 2 illustrates aggregation by an aggregator, in accordance with some embodiments;

FIG. 3 illustrates a comparison of the database entries by a database analyzer, in accordance with some embodiments;

FIG. 4 is a flow diagram of a method of detecting one or more side channels in a processor design, in accordance with some embodiments;

FIG. 5 is a flow diagram of a method of obtaining a program and a set of inputs for the program, in accordance with some embodiments;

FIG. 6 is a flow diagram of a method of comparing at least one contract trace and at least one hardware trace to determine whether there are one or more side-channel vulnerabilities, in accordance with some embodiments; and

FIG. 7 is a block diagram of an exemplary processor-based system that includes a processor (e.g., a microprocessor) that includes an instruction processing circuit for processing and executing instructions loaded from a memory such as an instruction cache and/or a system memory, in accordance with some embodiments.

### DETAILED DESCRIPTION

Embodiments of systems and methods utilizing hardware models to detect side-channel vulnerabilities in processor designs are disclosed. Programs and inputs are tested in an instruction set simulator, which implements a speculation contract. Implementing the processor design in the instruction set simulator generates contract traces that indicate the data and execution observable in accordance with the speculation contract for the processor design. In addition, a hardware simulator is implemented of the processor design. Implementing the hardware simulator results in hardware traces that indicate the data and execution are observable as a result of the hardware simulation. If the data and execution indicated by any of the hardware traces that correspond to contract traces within the same input class are not the same, a side-channel vulnerability is detected. Since the side-channel vulnerability was detected using a hardware simulation, an actual physical processor with the hardware design does not have to be used to test the hardware for the processor design.

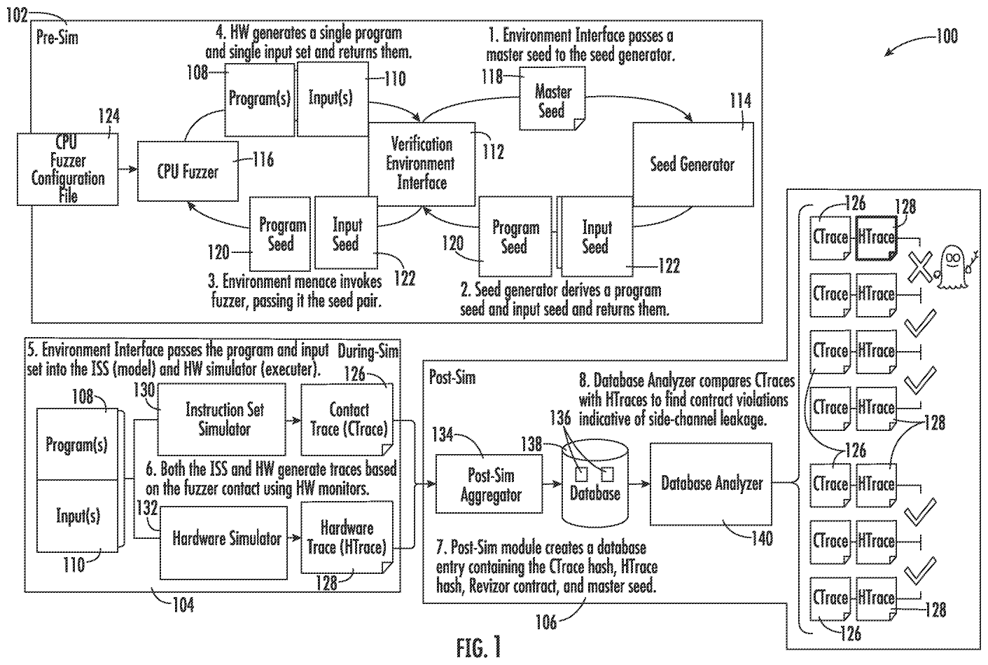

FIG. 1 is a side-channel vulnerability detection module 100, in accordance with some embodiments.

The side-channel vulnerability detection module 100 shown in FIG. 1 is a data and software representation of the side-channel vulnerability detection module 100. The processes described by the side-channel vulnerability detection module 100 shown in FIG. 1 are implemented by one or more processors and at least one non-transitory computer readable medium, examples of which are discussed below. In some embodiments, the side-channel vulnerability detection module 100 is a submodule of another software module. In some embodiments, the side-channel vulnerability detection module 100 is an independent and stand-alone software module.

The side-channel vulnerability detection module 100 shown in FIG. 1 describes a framework that utilizes a speculation contract (e.g., Model-based Relational Testing (MRT) contract in Revizor) and a hardware simulation to detect side-channel vulnerabilities in a hardware design, such as a processor design. Information leakage, which is detected in the hardware simulation but that was not indicated as permissible in the speculation contract, is a side-channel vulnerability. By utilizing a hardware simulation (e.g., an in-silico processor) instead of actually implementing the processor design in a physical processor, side-channel vulnerabilities are detected thereby allowing for the processor design to be modified to remove the side-channel vulnerability without actually having to create a physical processor. In some embodiments, the side-channel vulnerability detection module 100 integrates a hardware simulation in a pre-silicon environment to validate a central processing unit (CPU) during development and detect microarchitectural side channels during the early stages of design and verification.

The side-channel vulnerability detection module 100 shown in FIG. 1 includes a pre-simulation setup module (captioned as “Pre-Sim” in FIG. 1) 102, during-simulation module (captioned as “During-Sim” in FIG. 1) 104, and post-simulation module (captioned as “Post-Sim” in FIG. 1) 106. The pre-simulation setup module 102, the during-simulation module 104, and the post-simulation module 106 are submodules of the side-channel vulnerability detection module 100. It should be noted that in some embodiments, the pre-simulation setup module 102 and/or the post-simulation module 106 are not provided depending on the specific software tools being implemented.

In FIG. 1, the pre-simulation setup module 102 is configured to generate the program(s) 108 and the input(s) 110 that are to be implemented by the during-simulation module 104. In FIG. 1, the pre-simulation setup module 102 has three software submodules: a verification environmental interface 112, a seed generator 114, and a side-channel CPU fuzzer (captioned as “CPU Fuzzer” in FIG. 1) 116. In some embodiments, the side-channel CPU fuzzer 116 is Revizor. To begin, the verification environmental interface 112 in FIG. 1 is configured to generate a master seed 118. The master seed 118 is a random seed produced for random stimulus generation of a randomly produced variable.

The verification environmental interface 112 is then configured to send the master seed 118 to the seed generator 114. The seed generator 114 uses the master seed 118 to generate a program seed 120 and an input seed 122. In some embodiments, the program seed 120 has a smaller number of possibilities for random program generation than the input seed 122 has for input generation. For example, in some embodiments, a number of possibilities of input generation from the input seed 122 is at least one order of magnitude greater than the number of possibilities of program generation from the program seed 120.

In some embodiments, the pre-simulation setup module 102 is configured to generate a smaller number of programs 108 and a greater number of inputs 110. In some embodiments, generating a smaller number of programs 108 and a greater number of inputs 110 results in lowering the amount of time that the during-simulation module 104 runs simulations while making the best use of every simulation that is run by the during-simulation module 104. This is because, in some embodiments, the side-channel CPU fuzzer 116, such as Revizor, cannot run as fast with hardware simulator. Every program and every set of inputs has to be run on its own simulation.

Consequently, the seed generator 114 is configured to generate the program seed 120 and the input seed 122 so that there is a specific ratio of the programs to inputs to be collated and in order to maximize the probability that a contract violation is found. Reducing the number of possible program seeds 120 while keeping the set of possible input seeds 122 largely enables for the same identical program 108 to be generated “at-random” multiple times while being fed a different set of inputs 110 during each simulation. This is needed to be able to collect execution information of the same program 108 across several different inputs 110. Reproducing results is also needed in pre-silicon environments to be able to debug issues and re-run tests.

Once the program seed 120 and the input seed 122 are generated by the seed generator 114, the program seed 120, and the input seed 122 are passed to the verification environmental interface 112. The execution capabilities of the side-channel CPU fuzzer 116 are not compatible with the pre-simulation capabilities of the side-channel CPU fuzzer 116 (e.g., Revizor). Consequently, the verification environmental interface 112 is configured to pass the program seed 120 and the input seed 122 to the side-channel CPU fuzzer 116 so that the verification environmental interface 112 prepares the program seed 120 and the input seed 122 to be used by the side-channel CPU fuzzer 116. In some embodiments, the verification environmental interface 112 is configured to augment the generic assembly programs of the side-channel CPU fuzzer 116. In some embodiments, the verification environmental interface 112 is configured to generate bare-metal programs compatible with the CPU configuration indicated by a CPU fuzzer configuration file 124 and architecture under validation, such as adding translation tables, memory maps, etc.

The side-channel CPU fuzzer 116 is configured to generate program(s) 108 and input(s) 110 based on the program seed 120 and the input seed 122. In some embodiments, the side-channel CPU fuzzer 116 is configured to generate one of the program(s) 108 based on one of the program seeds 120 and is configured to generate a set of inputs 110 for the program 108 from one of the input seeds 122. In some embodiments, various program seeds 120 and input seeds 122 are used wherein each program seed 120 is used to generate a different one of the program(s) 108 and each of the input seeds 122 is used to generate a different set of inputs 110.

The during-simulation module 104 is configured to generate one or more contract traces (captioned as “Contract Trace (CTrace)” in FIG. 1) 126 and one or more hardware traces (captioned as “Hardware Trace (HTrace)” in FIG. 1) 128 from the programs 108 and the inputs 110. In some embodiments, each of the programs 108 is associated with a different set of inputs 110. The same program 108 is run on the corresponding set of inputs 110 to generate a set of one or more contract traces 126 and a set of one or more hardware traces 128. The set of contract traces 126 and the set of hardware traces 128 can then be compared by the post-simulation module 106 to detect side-channel vulnerabilities, as explained in further detail below.

The during-simulation module 104 includes an instruction set simulator 130 and a hardware simulator 132. The instruction set simulator 130 is configured to simulate the functional behavior of a processor design but abstract the hardware details of the processor design architecture. The instruction set simulator 130 is configured to simulate the functional behavior of the processor design implementing a particular one of the programs 108 with a particular one of the inputs 110 to generate one or more contract traces 126. The instruction set simulator 130 is configured to simulate the functional behavior of the processor design with the particular one of the programs 108 for each of the inputs 110 of the set of inputs 110 corresponding to the particular program 108. The instruction set simulator 130 implements a speculation contract. Speculation contracts declare which instruction set architecture operations an attacker can observe through a side-channel, and which operations can speculatively change the control/data flow.

In some embodiments, a contract trace monitor is attached to the instruction set simulator 130 to gather information of the architectural state as each of the programs 108 as executed with a given one of the inputs 110. Input classes are generated for programs 108 and inputs 110 that have identical and/or related contract traces 126. Thus, for a given one of the program(s) 108 and a given one of the input(s) 110, the instruction set simulator 130 generates one or more contract traces 126. Each contract trace 126 indicates one or more operations that an attacker can observe through a side channel, and which operations can speculatively change the control/data flow for the particular program 108 and the particular input 110 implemented by the instruction set simulator 130. The contract traces 126 therefore represent an expected microarchitectural footprint based on the speculation contract.

The hardware simulator 132 is configured to simulate a hardware model of hardware corresponding to the processor design. In some embodiments, the hardware simulator 132 provides a logic level simulation of the hardware indicated by the processor design. In some embodiments, the hardware simulator 132 is a register transfer level (RTL) simulator. The hardware simulator 132 is configured to simulate the hardware of the processor design by implementing a particular one of the programs 108 with a particular one of the inputs to generate one or more hardware traces 128. In some embodiments, a hardware trace monitor is attached to the hardware simulator 132 to observe the modeled structures (e.g., caches) in the processor design and gather information (e.g., cache accesses) during the execution of each of the programs 108. The hardware traces 128 thus indicate the actual operations an attacker can observe through a side-channel, and which of the actual operations can speculatively change the control/data flow given the specifics of the hardware in the processor design. If the simulation of the hardware indicates that an attacker can observe more than (e.g., addresses of loads after mispredicted indirect jumps) what the speculation contract indicates should be observable, the hardware design violates the speculation contract, which thereby indicates a side-channel vulnerability in the hardware architecture of the processor design. The data generated by the hardware trace monitor can then be analyzed to determine what caused the side-channel vulnerability.

If there are no contract violations after execution of programs 108, the hardware traces 128 should be identical to other hardware traces in the same input class where contract traces 126 are identical. However, due to the enhancing features of speculative execution by the processor design, the hardware traces 128 corresponding to identical contract traces 126 can differ. In some embodiments, this occurs during speculative execution where the hardware traces 128 will show resource utilizations (e.g., cache reloads) which are not visible in the contract traces 126. These differences in hardware traces 128 given identical contract traces 126 indicate microarchitectural footprints left behind during speculative execution that can be exploited using timing side channels leading to microarchitectural side-channel vulnerabilities (e.g., Spectre). These differences in hardware traces 128 given identical contract traces 126 thereby indicate side-channel vulnerabilities.

The post-simulation module 106 is configured to organize the contract traces 126 and the hardware traces 128 in order to compare each of the hardware traces 128 to other hardware traces 128 in the same input class to determine whether there are any side-channel vulnerabilities. In some embodiments, the post-simulation module 106 implements an aggregator (captioned as “Post-Sim Aggregator” in FIG. 1) 134 that generates database entries 136 associating contract traces 126 and hardware traces 128. In some embodiments, each of the database entries 136 includes a hash for the contract trace 126, a hash for the hardware trace 128, an identifier for the speculative contract, and the master seed 118 associated with the program 108 and the input 110 that resulted in the contract trace 126 and the hardware trace 128. The database 138 is configured to store the database entries 136.

The post-simulation module 106 also includes a database analyzer 140. In some embodiments, the database analyzer 140 combines the programs 108 and the inputs 110 that match into input classes and then compares the contract traces 126 and the hardware traces 128. If one of the hardware traces 128 differs from the other hardware traces 128 that are members of the same input class, then a violation is flagged indicating that the hardware trace 128 and its corresponding program 108 contain a microarchitectural difference in the execution of the same program given a specific input 110. That microarchitectural difference indicates there is a footprint left behind in the microarchitecture after execution and thus a side-channel vulnerability. Consequently, the contract trace 126 that is associated with the hardware trace 128 also does not match. For example, if the hardware trace 128 that does not match relates to cache, a footprint was left in the cache that indicates a Spectre-like side-channel vulnerability which can be exploited using a timing side-channel attack.

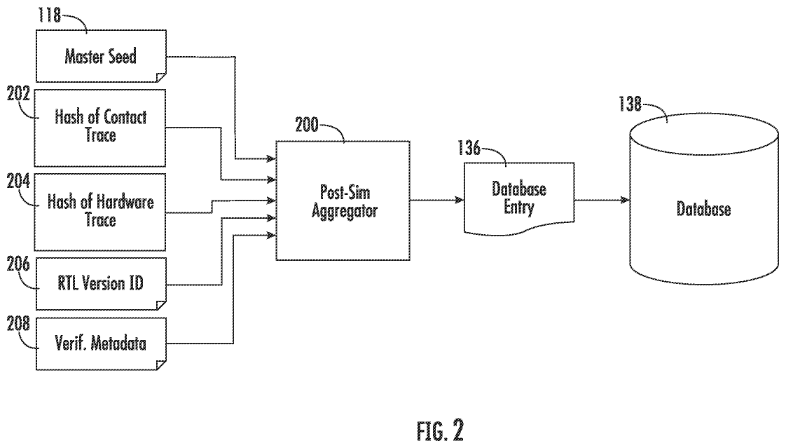

FIG. 2 illustrates aggregation by an aggregator 200, in accordance with some embodiments.

In some embodiments, the aggregator 134 shown in FIG. 1 is implemented as the aggregator (captioned as “Post-Sim Aggregator” in FIG. 2) 200 shown in FIG. 2. FIG. 2 illustrates a data and software implementation of aggregation performed by the aggregator 200, in accordance with some embodiments. The aggregator 134 is responsible for organizing and storing simulation results across numerous simulation runs implemented by the during-simulation module 104 shown in FIG. 1. This makes searching the results of simulation runs for side-channel vulnerabilities much more efficient.

As shown in FIG. 2, the aggregator 200 is configured to store the master seed 118, a hash 202 of the contract trace 126 (See FIG. 1 for the contract trace 126), a hash 204 of the hardware trace 128 (See FIG. 1 for the hardware trace 128), an RTL version identifier (ID) (captioned as “RTL Version ID” in FIG. 2) 206 that identifies a hardware model of the processor design, and verification metadata (captioned as “Verif. Metadata” in FIG. 2) 208. The verification metadata 208 is associated with the simulation run that resulted in the contract trace 126 and the hardware trace 128 and includes data specific to the verification environment.

The master seed 118 is used to create the program 108 and input 110 for the simulation run, as explained above with respect to FIG. 1. Accordingly, the master seed 118 and the RTL version identifier 206 are used in some embodiments to rerun an identical simulation. The contract trace 126 and hardware trace 128 are thus also associated with the master seed 118 and the RTL version identifier 206. As such, rather than storing the trace files themselves, the aggregator 200 is configured to implement a hashing algorithm that generates a hash 202 of the contract trace 126 and a hash 204 of the hardware trace 128. The hashes 202, 204 will be used for trace comparisons to find contract violations, as explained in further detail below. In some embodiments, the aggregator 200 is configured to generate the hashes 202, 204 using as little trace information as possible (only what's necessary) to prevent extra simulation output information from polluting the comparisons. In some embodiments, the speculation contract name specifies what information was collected inside the traces 126, 128. The aggregator 200 includes this field to provide an analyst insight into potential side-channel leakage discovered during the simulation. The verification metadata 208 includes relevant data describing the environment as well as specified configuration data for the simulation, in accordance with some embodiments.

The data (e.g., the master seed 118, the hash 202, the hash 204, the RTL version ID 206, the verification metadata 208) collected by the aggregator 200 for a specific simulation is provided in the database entry 136, which is then stored in the database 138. In some embodiments, the organization of the database entries 136 in database 138 is configurable so that engineers can select how to organize storage of the database entries 136 for thousands of simulations based on specified characteristics described in the verification metadata 208.

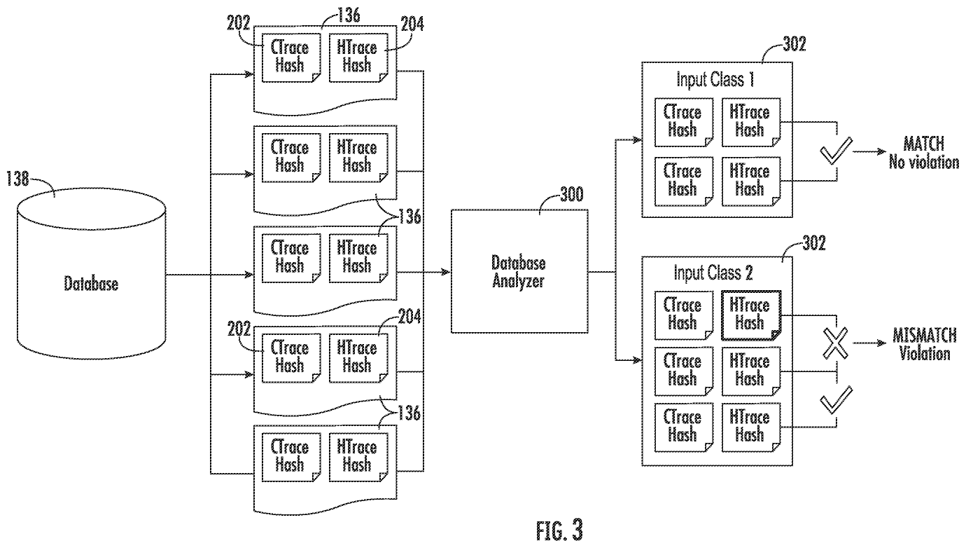

FIG. 3 illustrates a comparison of the database entries 136 by a database analyzer 300, in accordance with some embodiments.

In some embodiments, the database analyzer 140 shown in FIG. 1 is provided in the same manner as the database analyzer 300 shown in FIG. 3. The database analyzer 300 is implemented to compare the contract traces 126 (See FIG. 1) and the hardware traces 128 (See FIG. 1) to determine one or more side-channel vulnerabilities by detecting a mismatch between the hardware traces 128 corresponding to contract traces 126 in the same input class. In FIG. 3, the hash 202 and the hash 204 in the database entries 136 are used to compare the contract traces 126 and the hardware traces 128.

To compare the contract traces 126 and the hardware traces 128, the database analyzer 300 iterates through the database entries 136 and organizes the database entries 136 into groups 302. The groups 302 organize the database entries 136 by input classes based on matching contract traces 126 associated with the hash 202. Each input class includes a group of matching contract traces 126. Two contract traces 126 are considered to “match” when their contents are equivalent. In some embodiments, a hashing algorithm is implemented to generate a hash string based on the contents of each contract trace 126 so as to generate the hash 202. The hash strings corresponding to the two contract traces 126 are then compared to determine the equivalency of the two contract traces 126. Each of the hardware traces 128 are expected to match other hardware traces 128 within the same group 302. Within each of the groups 302, the database analyzer 300 looks for hardware traces 128 that are mismatched with other hardware traces 128 within the same group 302. If one of the hardware traces 128 does not match the other hardware traces 128 within the group 302, a side-channel vulnerability is reported.

In some embodiments, a contract trace hash 202 is generated solely based on content of a corresponding contract trace 126. In some embodiments, a hardware trace hash 204 is generated solely based on content of a corresponding hardware trace 128.

In some embodiments, contract traces 126 and hardware traces 128 are never directly compared against one another but instead are compared indirectly. Instead, several contract traces 126 (all generated using the same program 108, with different inputs 110 to that program 108) are compared against one another. Any of those contract traces 126 that match are considered to be part of the same “input class,” which is also referred to as a group 302.

Once the groups 302 are formed, those corresponding hardware traces 128 (which are generated by running the same inputs 110 and the same program 108 as the contract traces 126 in the group 302) are compared against one another. If any mismatch is found between those hardware traces 128 within the same group 302, there is a side-channel vulnerability. In some embodiments, the comparison of the contract traces 126 and the hardware traces 128 are performed using the hashes 202, 204. These hashes 202, 204 are similar signatures created for each simulation. All simulations that are identical will have an identical hash. Any difference between the traces 126, 128, such as a single bit flip, will create a completely different hash 202, 204.

In some embodiments, hashes 202, 204 are each of a fixed length. In some embodiments, if we use the hashing algorithm SHA3-256, then all hashes will be 256 bits in length. In this manner, the entire simulation results (which could be thousands of characters in length) do not have to be stored.

Therefore, to determine a group 302 (i.e., input class) all contract traces 126 that are identical will produce the same hash 202. The contract traces 126 with the same hash 202 are therefore placed in the same group 302 along with the hardware traces 128 that correspond to the contract traces 126 having the same hash 202. The hashes 204 of the hardware traces 128 within the same group 302 are compared to one another. If there is a mismatch between the hashes 204 of the hardware traces 128 within the same group 302, a side-channel vulnerability is identified within respect to the non-matching hardware trace 128. As mentioned above, the hashes 202, 204 are all the same length in some embodiments. Therefore, the hashes 202, 204 to group and then find mismatches is an efficient way to find side-channel vulnerabilities. Once the database analyzer 300 reports a violation, the master seed 118 and the RTL version ID 206 stored in the database entry 136 can be used to recreate the simulation to investigate the cause of the side-channel vulnerability. In this manner, the processor design can be reconfigured to remove the side-channel vulnerability.

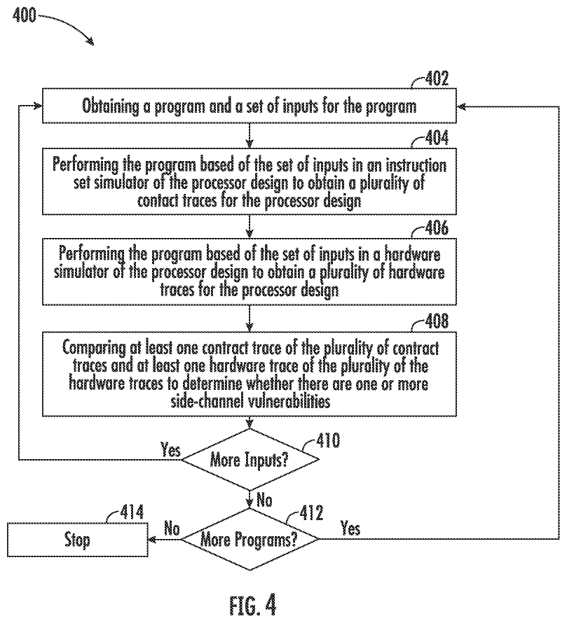

FIG. 4 is a flow diagram 400 of a method of detecting one or more side channels in a processor design, in accordance with some embodiments.

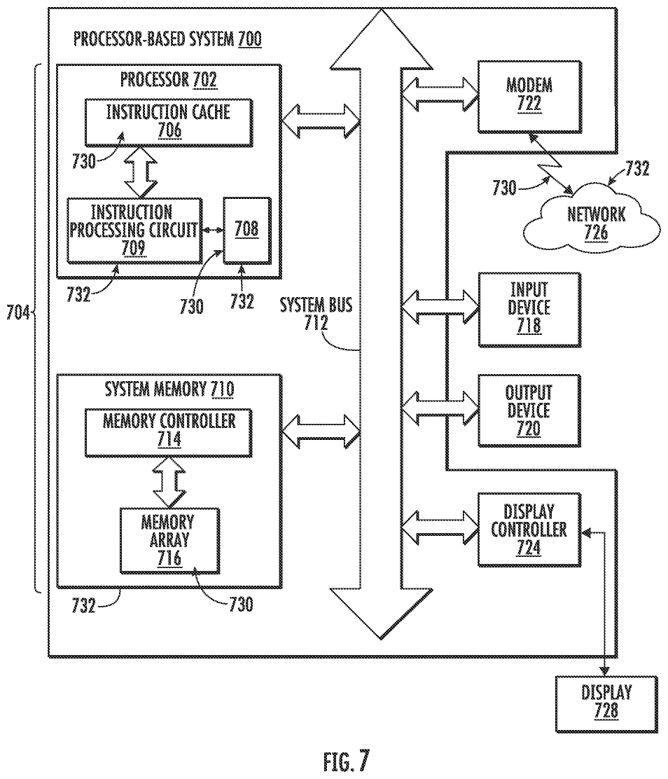

In some embodiments, the flow diagram 400 is implemented by an exemplary processor-based system 700 shown in FIG. 7 below. In some embodiments, the processor-based system 700 implements the side-channel vulnerability detection module 100 shown in FIG. 1 in order to implement the flow diagram 400. Flow diagram 400 includes blocks 402-414. Flow begins at block 402.

At block 402, a program and a set of inputs for the program are obtained. Examples of the program include each of the program(s) 108 shown in FIG. 1. Examples of the inputs include each of the input(s) 110 shown in FIG. 1. In some embodiments, block 402 is performed by implementing the pre-simulation setup module 102. Flow then proceeds to block 404.

At block 404, the program is performed based of the set of inputs in an instruction set simulator of the processor design to obtain a plurality of contract traces for the processor design. An example of the instruction set simulator is the instruction set simulator 130 shown in FIG. 1, which is provided by the during-simulation module 104. In some embodiments, the instruction set simulator 130 performs one simulation of the program for every input in the set of inputs 110. In some embodiments, the instruction set simulator 130 implements a speculation contract, such as an MRT contract in order to generate the contract traces. An example of the contract traces are the contract traces 126 shown in FIG. 1. Flow then proceeds to block 406.

At block 406, the program based of the set of inputs is performed in a hardware simulator of the processor design to obtain a plurality of hardware traces for the processor design. An example of the hardware simulator is the hardware simulator 132 shown in FIG. 1, which is provided by the during-simulation module 104. In some embodiments, the hardware simulator 132 performs one simulation of the program for every input in the set of inputs 110. In some embodiments, the hardware simulator 132 is an RTL simulator. An example of the hardware traces are the hardware traces 128 shown in FIG. 1. Flow then proceeds to block 408.

At block 408, at least one contract trace of the plurality of contract traces is compared and at least one hardware trace of the plurality of the hardware traces 128 to determine whether there are one or more side-channel vulnerabilities. In some embodiments, block 408 is performed by determining whether any of the plurality of the hardware traces 128 do not match other hardware traces 128 that correspond to identical contract traces 126 (i.e., contract traces 126 that correspond to the same input class). When one of the hardware traces 128 does not match the other hardware traces 128 within the same input class, a side-channel vulnerability has been identified. In some embodiments, block 408 is performed by implementing the post-simulation module 106 shown in FIG. 1. Flow then proceeds to block 410.

At block 410, a determination is made whether there are any more inputs to implement for the program. If there are more inputs 110, then flow progresses back to block 402 so that blocks 402-408 are performed on the program 108 and the new set of inputs 110. If there are no more inputs for the program, flow proceeds to block 412.

At block 412, a determination is made whether there are any more programs to be implemented to detect side-channel vulnerabilities. If there are more programs 108, blocks 402-410 are implemented for the new program 108. If there are no more programs 108 to be simulated, flow proceeds to block 414 where flow diagram 400 stops.

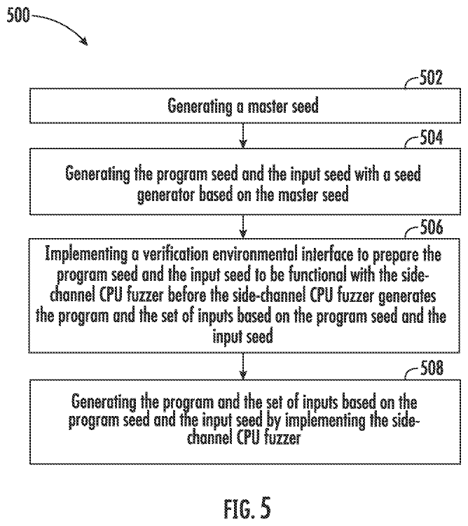

FIG. 5 is a flow diagram 500 of a method of obtaining a program and a set of inputs for the program, in accordance with some embodiments.

In some embodiments, block 402 in FIG. 4 is performed by implementing flow diagram 500. In some embodiments, the flow diagram 500 is implemented by the exemplary processor-based system 700 shown in FIG. 7 below. In some embodiments, the processor-based system 700 implements the pre-simulation set up module 102 shown in FIG. 1 in order to implement the flow diagram 500. Flow diagram 500 includes blocks 502-508. Flow begins at block 502.

At block 502, a master seed is generated. An example of the master seed is the master seed 118 shown in FIG. 1 and FIG. 2. In some embodiments, the verification environmental interface 112 shown in FIG. 1 is configured to generate the master seed 118. Flow then proceeds to block 504.

At block 504, a program seed and an input seed are generated with a seed generator based on the master seed. An example of the program seed is the program seed 120 shown in FIG. 1. An example of the input seed is the input seed 122 shown in FIG. 1. An example of the seed generator is the seed generator 114 shown in FIG. 1. In some embodiments, the program seed 120 and the input seed 122 are generated so that more inputs 110 are generated than programs 108 for simulations. Flow then proceeds to block 506.

At block 506, the verification environmental interface is implemented to prepare the program seed and the input seed to be functional with a side-channel CPU fuzzer before the side-channel CPU fuzzer generates the program and the set of inputs 110 based on the program seed 120 and the input seed 122. An example of the side-channel CPU fuzzer is the side-channel CPU fuzzer 116. In some embodiments, the verification environmental interface 112 is configured to augment the generic assembly programs of the side-channel CPU fuzzer 116. In some embodiments, the verification environmental interface 112 is configured to generate bare-metal programs compatible with the processor design configuration indicated by a CPU fuzzer configuration file and architecture under validation, such as adding translation tables, memory maps, etc. Flow then proceeds to block 508.

At block 508, the program and the set of inputs are generated based on the program seed 120 and the input seed 122 by implementing the side-channel CPU fuzzer 116. In some embodiments, the side-channel CPU fuzzer is Revizor.

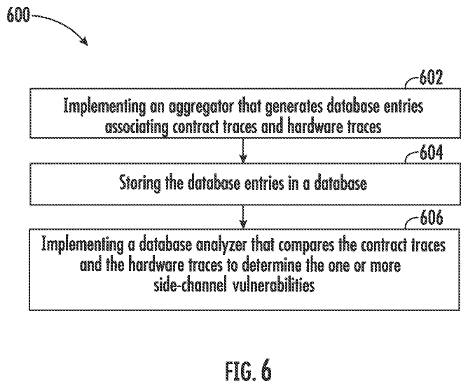

FIG. 6 is a flow diagram 600 of a method of comparing at least one contract trace and at least one hardware trace to determine whether there are one or more side-channel vulnerabilities, in accordance with some embodiments.

In some embodiments, block 408 in FIG. 4 is performed by implementing flow diagram 600. In some embodiments, the flow diagram 600 is implemented by the exemplary processor-based system 700 shown in FIG. 7 below. In some embodiments, the processor-based system 700 implements the post-simulation module 106 shown in FIG. 1 in order to implement the flow diagram 600. Flow diagram 600 includes blocks 602-606. Flow begins at block 602.

At block 602, an aggregator is implemented that generates database entries associating contract traces and hardware traces. An example of the aggregator is the aggregator 134 shown in FIG. 1. An example of the contract trace is each of the contract trace(s) 126 shown in FIG. 1. An example of the hardware traces is each of the hardware trace(s) 128 shown in FIG. 1. An example of the database entries are the database entries 136 shown in FIG. 1. Flow then proceeds to block 604.

At block 604, the database entries 136 are stored in a database. An example of the database is the database 138 shown in FIG. 1. Flow then proceeds to block 606.

At block 606, a database analyzer is implemented that compares the contract traces and the hardware traces to determine the one or more side-channel vulnerabilities. An example of the database analyzer is the database analyzer 140 shown in FIG. 1. In some embodiments, the database analyzer 140 detects current Spectre variants. In some embodiments, due to the techniques used to in generate programs 108 and inputs 110 based on the input seed 122 and master seed 118, previously unknown or undisclosed side-channel vulnerabilities are detected, whether those are new Spectre variants or a new type of microarchitectural side-channel vulnerability. In some embodiments, the database analyzer compares a set of hardware traces, where the hardware traces in the set of hardware traces correspond to contract traces within the same input class. When there is a mismatch between one of the hardware traces and the other hardware traces in the set of hardware traces, a side-channel vulnerability is detected.

FIG. 7 is a block diagram of an exemplary processor-based system 700 that includes a processor 702 (e.g., a microprocessor) that includes an instruction processing circuit 709 for processing and executing instructions loaded from a memory such as an instruction cache 706 and/or a system memory 710, in accordance with some embodiments.

In some embodiments, the processor-based system 700 is used to implement the side-channel vulnerability detection module 100 of FIG. 1. In some embodiments, the processor-based system 700 is used to implement the side-channel vulnerability detection module 100 of FIG. 1, the aggregator 200 of FIG. 2, the database analyzer 300 of FIG. 3, the flow diagram 400 of FIG. 4, the flow diagram 500 of FIG. 5, and/or the flow diagram 600 of FIG. 6. It should be noted that the processor-based system 700 is simply an example and any other suitable processor-based system can be used to implement the side-channel vulnerability detection module 100 of FIG. 1, the aggregator 200 of FIG. 2, the database analyzer 300 of FIG. 3, the flow diagram 400 of FIG. 4, the flow diagram 500 of FIG. 5, and/or the flow diagram 600 of FIG. 6. These and other processor-based systems would be apparent to one of ordinary skill in the art in light of this disclosure.

The processor-based system 700 also includes a memory system 704 that includes one or more memory arrays 716 that each include multiple memory banks. The memory system 704 in this example includes an instruction cache 706, a data cache 708, and a system memory 710. Other embodiments may have any suitable arrangement of the memory system 704.

With continuing reference to FIG. 7, the processor-based system 700 may be a circuit or circuits included in an electronic board card, such as, a printed circuit board (PCB), a server, a personal computer, a desktop computer, a laptop computer, a personal digital assistant (PDA), a computing pad, a mobile device, or any other device, and may represent, for example, a server or a user's computer. The processor 702 represents one or more general-purpose processing circuits, such as a microprocessor, central processing unit, or the like. The processor 702 includes an instruction processing circuit 709 configured to execute processing logic in computer instructions for performing the operations and steps discussed herein. The processor 702 also includes the instruction cache 706 for temporary, fast access memory storage of instructions. Fetched or prefetched instructions from a memory, such as from a system memory 710 over a system bus 712, are stored in the instruction cache 706. The processor 702 also includes a data cache 708 for temporary, fast access memory storage of data from the system memory 710 over the system bus 712.

The processor 702 and the system memory 710 are coupled to the system bus 712 and can intercouple peripheral devices included in the processor-based system 700. As is well known, the processor 702 communicates with these other devices by exchanging address, control, and data information over the system bus 712. For example, the processor 702 can communicate bus transaction requests to a memory controller 714 in the system memory 710 as an example of a slave device. Although not illustrated in FIG. 7, multiple system buses 712 could be provided, wherein each system bus constitutes a different fabric. In this example, the memory controller 714 is configured to provide memory access requests to a memory array 716 in the system memory 710. The memory array 716 is comprised of an array of storage bit cells for storing data. The system memory 710 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 712. As illustrated in FIG. 7, these devices can include the system memory 710, one or more input device(s) 718, one or more output device(s) 720, a modem 722, and one or more display controllers 724, as examples. The input device(s) 718 can include any type of input device, including but not limited to input keys, switches, voice processors, etc. The output device(s) 720 can include any type of output device, including but not limited to audio, video, other visual indicators, etc. The modem 722 can be any device configured to allow exchange of data to and from a network 726. The network 726 can be any type of network, including but not limited to a wired or wireless network, a private or public network, a local area network (LAN), a wireless local area network (WLAN), a wide area network (WAN), a BLUETOOTH™ network, and the Internet. The modem 722 can be configured to support any type of communications protocol desired. The processor 702 may also be configured to access the display controller(s) 724 over the system bus 712 to control information sent to one or more displays 728. The display(s) 728 can include any type of display, including but not limited to a cathode ray tube (CRT), a liquid crystal display (LCD), a plasma display, etc.

The processor-based system 700 in FIG. 7 may include a set of instructions 730 that when executed by a processor, such as processor 702, perform serialization of read data from the memory system 704 by converting parallel data streams of read data received from separately switched memory banks into a single, serialized, read data stream to be provided on the output bus in a burst read mode, and/or perform de-serialization of write data communicated to the memory system 704 to be written by converting a received, serialized write data stream on an input bus for a write operation into separate, parallel write data streams to be written simultaneously to the memory banks in a burst write mode. The instructions 730 may be stored in the system memory 710, processor 702, and/or instruction cache 706 as examples of non-transitory computer-readable medium 732. The instructions 730 may also reside, completely or at least partially, within the system memory 710 and/or within the processor 702 during their execution. The instructions 730 may further be transmitted or received over the network 726 via the modem 722, such that the network 726 includes the non-transitory computer-readable medium 732, or the input device 718 as other examples.

While the non-transitory computer-readable medium 732 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A method of detecting one or more side channels in a processor design, comprising:
obtaining a program and a set of inputs for the program;
performing the program based off the set of inputs in an instruction set simulator of the processor design to obtain a plurality of contract traces for the processor design;
performing the program based off the set of inputs in a hardware simulator of the processor design to obtain a plurality of hardware traces for the processor design; and
comparing at least one contract trace of the plurality of contract traces and at least one hardware trace of the plurality of the hardware traces to determine whether there are one or more side-channel vulnerabilities.

2. The method of claim 1, further comprising:
obtaining a set of programs and sets of inputs, wherein each set of inputs of the sets of inputs corresponds to a different program of the set of programs and wherein obtaining the set of programs and the sets of inputs comprises obtaining the program and the set of inputs for the program;
performing each one of the programs in the set of programs based on the corresponding set of inputs in the instruction set simulator of the processor design to obtain pluralities of contract traces for the processor design, wherein each of the pluralities of contract traces corresponds to a different one of the programs and a different set of the inputs, wherein performing each one of the programs based on the corresponding set of inputs in the instruction set simulator of the processor design comprises performing the program based of the set of inputs in the instruction set simulator of the processor design to obtain the plurality of contract traces for the processor design;
performing each one of the programs in the set of programs based on the corresponding set of inputs in the hardware simulator of the processor design to obtain pluralities of hardware traces for the processor design, wherein each of the pluralities of the hardware traces corresponds to a different one of the programs and a different set of the inputs, wherein performing each one of the programs based on the corresponding set of inputs in the hardware simulator comprises performing the program based of the set of inputs in the hardware simulator of the processor design to obtain the plurality of hardware traces for the processor design; and
comparing the at least one contract trace of each of the pluralities of contract traces and the at least one hardware trace of each of the pluralities of the hardware traces to determine whether there are one or more side-channel vulnerabilities, wherein comparing the at least one contract trace of each of the pluralities of contract traces and the at least one hardware trace of each of the pluralities of the hardware traces to determine whether there are one or more side-channel vulnerabilities comprises comparing the at least one contract trace of the plurality of contract traces and the at least one hardware trace of the plurality of the hardware traces to determine whether there are one or more side-channel vulnerabilities.

3. The method of claim 1, wherein comparing the at least one contract trace of the plurality of contract traces and the at least one hardware trace of the plurality of the hardware traces to determine whether there are one or more side-channel vulnerabilities comprises:
determining one or more groups of contract traces, each group of contract traces includes contract traces generated as a result of implementing the same program with different inputs;
for each of the one or more groups of contract traces, comparing corresponding hardware traces to one another to determine whether there is a mismatch between any of the hardware traces;
for each group of the one or more groups of contract traces, detect a side-channel vulnerability of the one or more side-channel vulnerabilities for each instance that there is mismatch between any of the hardware traces in the group.

4. The method of claim 1, wherein the program is a first program, the set of inputs is a first set of inputs, the plurality of contract traces are first contract traces, the plurality of hardware traces are first hardware traces, the one or more side-channel vulnerabilities are one or more first side-channel vulnerabilities, the method further comprising:
obtaining a second program and a second set of inputs for the second program;
implementing the second set of inputs and the second program in the instruction set simulator of the processor design to obtain second contract traces;
implementing the second set of inputs and the second program in the hardware simulator of the processor design to obtain second hardware traces; and
comparing the second contract traces and the second hardware traces to determine whether there are one or more second side-channel vulnerabilities.

5. The method of claim 1, wherein obtaining the program and the set of inputs for the program comprises generating the program and the set of inputs with a side-channel central processing unit (CPU) fuzzer that generates the program and the set of inputs based on a program seed and an input seed.

6. The method of claim 5, further comprising:
generating a master seed; and
generating the program seed and the input seed with a seed generator based on the master seed.

7. The method of claim 6, further comprising implementing a verification environmental interface to prepare the program seed and the input seed to be functional with the side-channel CPU fuzzer before the side-channel CPU fuzzer generates the program and the set of inputs based on the program seed and the input seed.

8. The method of claim 1, wherein comparing at least one contract trace of the plurality of contract traces and at least one hardware trace of the plurality of hardware traces to determine whether there are one or more side-channel vulnerabilities comprises:
implementing an aggregator that generates database entries associating contract traces and hardware traces;
storing the database entries in a database; and
implementing a database analyzer that compares the contract traces and the hardware traces to determine the one or more side-channel vulnerabilities.

9. The method of claim 8, wherein obtaining the program and the set of inputs for the program comprises generating the program and the set of inputs with a side-channel central processing unit (CPU) fuzzer that generates the program and the set of inputs based on a program seed and an input seed.

10. The method of claim 9, further comprising:
generating a master seed; and
generating the program seed and the input seed with a seed generator based on the master seed.

11. The method of claim 10, further comprising implementing a verification environmental interface to prepare the program seed and the input seed to be functional with the side-channel CPU fuzzer before the side-channel CPU fuzzer generates the program and the set of inputs based on the program seed and the input seed.

12. The method of claim 1, wherein performing the program based off the set of inputs in an instruction set simulator of the processor design to obtain a plurality of contract traces for the processor design comprises implementing the instruction set simulator in accordance with a speculation contract that indicates the contract traces based on the program and the set of inputs.

13. The method of claim 1, wherein the hardware simulator of the processor design is a register transfer level (RTL) simulator.

14. A computational device, comprising:
one or more processors; and
a non-transitory computer readable medium that stores computer executable instructions, wherein, in response to executing the computer executable instructions, the one or more processors are configured to:
obtain a program and a set of inputs for the program;
implement the set of inputs and the program in an instruction set simulator of a processor design to obtain contract traces;
implement the set of inputs and the program in a hardware simulator of the processor design to obtain hardware traces; and
compare the contract traces and the hardware traces to determine whether there are one or more side-channel vulnerabilities.

15. The computational device of claim 14, wherein the program is a first program, the set of inputs is a first set of inputs, the contract traces are first contract traces, the hardware traces are first hardware traces, the one or more side-channel vulnerabilities are one or more first side-channel vulnerabilities, wherein, in response to executing the computer executable instructions, the one or more processors are further configured to:
obtain a second program and a second set of inputs for the second program;
implement the second set of inputs and the second program in the instruction set simulator of the processor design to obtain second contract traces;
implement the second set of inputs and the second program in the hardware simulator of the processor design to obtain second hardware traces; and
compare the second contract traces and the second hardware traces to determine whether there are one or more second side-channel vulnerabilities.

16. The computational device of claim 14, wherein to obtain the program and the set of inputs for the program, the one or more processors are configured to generate the program and the set of inputs with a side-channel central processing unit (CPU) fuzzer that generates the program and the set of inputs based on a program seed and an input seed.

17. The computational device of claim 16, wherein, in response to executing the computer executable instructions, the one or more processors are further configured to:
generate a master seed; and
generate the program seed and the input seed with a seed generator based on the master seed.

18. The computational device of claim 14, wherein to compare the contract traces and the hardware traces to determine whether there are one or more side-channel vulnerabilities, the one or more processors are configured to:
implement an aggregator that generates database entries associating the contract traces and the hardware traces;
store the database entries in a database; and
implement a database analyzer that compares the contract traces and the hardware traces to determine the one or more side-channel vulnerabilities.

19. A non-transitory computer readable medium that stores computer executable instructions, wherein, in response to executing the computer executable instructions, one or more processors are configured to:
obtain a program and a set of inputs for the program;
implement the set of inputs and the program in an instruction set simulator of a processor design to obtain contract traces;
implement the set of inputs and the program in a hardware simulator of the processor design to obtain hardware traces; and
compare the contract traces and the hardware traces to determine whether there are one or more side-channel vulnerabilities.

20. The non-transitory computer readable medium of claim 19, wherein to obtain the program and the set of inputs for the program, the one or more processors are configured to generate the program and the set of inputs with a side-channel central processing unit (CPU) fuzzer that generates the program and the set of inputs based on a program seed and an input seed.

21. The non-transitory computer readable medium of claim 19, wherein to compare the contract traces and the hardware traces to determine whether there are one or more side-channel vulnerabilities, the one or more processors are configured to:
implement an aggregator that generates database entries associating the contract traces and the hardware traces;
store the database entries in a database; and
implement a database analyzer that compares the contract traces and the hardware traces to determine the one or more side-channel vulnerabilities.
